(19) United States
(12) Patent Application Publication
(10) Pub. No.: US 2007/0166444 A1
(43) Pub. Date: Jul. 19, 2007

(54) METHOD AND SYSTEM FOR COOLING SPONGY HEATED FOOD

(75) Inventors: Tadaoki NARUMIYA, Tokyo (JP); Hiroshi OKADA, Tokyo (JP); Satoshi SHINOZAKI, Tokyo (JP); Syoji MIYAJIMA, Tokyo (JP)

Correspondence Address: ROSSI, KIMMS & McDOWELL LLP., P.O. BOX 826, ASHBURN, VA, 20146-0826, US

(73) Assignee: MAYEKAWA MFG. CO., LTD., Tokyo (JP)

(21) Appl. No.: 11/623,076

(22) Filed: Jan. 13, 2007

Related U.S. Application Data
(63) Continuation of application No. PCT/JP04/16459, filed on Oct. 29, 2004.

(30) Foreign Application Priority Data
Jul. 13, 2004 (JP) 2004-205396
Jul. 13, 2004 (JP) 2004-205391

(51) Int. Cl. A23L 3/36

(52) U.S. Cl. 426/524; 426/549

(57) ABSTRACT

A method and a system for cooling spongy heated food, after final heating operation, such as baking for spongy heated foods, such as baked bread, are cooled while being exposed to three different atmosphere conditions, namely a first zone for applying water to the surface of spongy heated food that have undergone a final heating operation, a second zone for promoting cooling of spongy heated food by using the latent heat of evaporation of applied water, and a third zone for retaining the spongy heated food cooled in the second zone in an atmosphere of dew point temperature higher than the surface temperature of spongy heated food. The humidity is maintained higher in the third zone than in the second zone to permit the spongy heated food to absorb moisture. The first, second, and third zones all can be located in a single cooling chamber. Moreover, the first, second, and third zones all can be located within the same physical space at different times.

This is a continuation of International Application PCT/JP2004/016459 (published as WO 2006/006261) having an international filing date of 29 Oct. 2004, which claims priority to JP 2004-205391 and JP 2004-205396 both filed on 13 Jul. 2004. The disclosures of the priority applications, in its entirety, including the drawings, claims, and the specifications thereof, are incorporated herein by reference.

### BACKGROUND

The surface of sliced bread that has been baked at a high temperature typically is not smooth. Also, when packaging baked bread having a temperature higher than a packaging chamber, condensation forms inside the packaging. Cooling baked bread can attain a smooth sliced surface and to prevent condensation inside the packaging. Baked bread can be placed on a shelf-like conveyor inside a production chamber, or transferred on a bar conveyor, spiral conveyor or the like placed near the ceiling to cool naturally at the room temperature of the production chamber for two to three hours to bring the core temperature to approximately 25° C., which is the room temperature of a slicing/packaging chamber. However, without controlling the temperature and humidity inside the production chamber, the bread temperature can fluctuate and water evaporation still can occur, depending on the season, time, and relation with other production processes. Thus, to reduce the fluctuations, a more advanced cooling method have been contemplated, such as placing baked bread on a shelf-like conveyor or the like in a cooling chamber and controlling the temperature and an air speed blowing on baked bread, or the temperature and humidity.

A set of temperature and humidity settings inside a cooling chamber are controlled by providing two zones in the cooling chamber, namely a high temperature room and a low temperature room. The temperature and humidity are controlled to 25 to 40° C. and 70% RH in the high temperature room, and to 20 to 25° C. and 60% RH (±10% RH) in the low temperature room. Baked bread is transferred from the high temperature room to the low temperature room. The air speed against the product is 0.1 to 2 m/sec in the cooling chamber.

All of these conventional methods focus on the temperature of the cooled product and the room temperature of the cooling chamber to determine the condition inside the cooling chamber, but do not focus on water evaporation occurring in baked bread. JP 62-531432A and JP 8-70837A, for instance, disclose an improved method of cooling food, where the temperature of the cooling chamber is set lower than that of the food, while the relative humidity is set as high as saturation humidity. The cooling speed is increased and water evaporation from the food is controlled, to shorten the cooling period and to improve the yield rate and the texture of baked bread. However, when baked bread having a high temperature contacts saturated air at 100% RH, the air temperature rises while the relative humidity decreases due to sensible heat of the food. Thus, the above method still does not evade the problem of water evaporating from the food.

As water vapor is dispersed in the air to maintain humidity, when baked bread contacts the air, the evaporative latent heat therefrom is unlikely to be released. Also, as the humidity in the ambient air is saturated, water evaporation from baked bread is suppressed. Thus, the cooling period cannot be shortened. The above method requires a large space and consumes more calories for the cooling. Moreover, as the humidity inside the cooling chamber is high, problems such as microbes growing inside the chamber also become an issue.

JP 8-103256A discloses a method of cooling food in which water and air, or water alone is sprayed on the surface of food to keep the surface moist, cooling air is blown to cool the food, and dry cooling air is supplied to cool and take surplus moisture from the food. Here, the cooling speed may be enhanced, but the yield rate is lowered by applying the cooling step of blowing cooling air and the surplus moisture removal step of blowing dry cooling air, which evaporates moisture from the surface of the food, making the surface of food dry.

A freezing method of fully baked or half baked bread to prevent crust flaking and cracking and enhance bread texture is disclosed in JP 55-034656B and JP 2003-219794A. According to these references, water is sprayed, brushed, or dipped on the bread surface before (JP55-34656B) or after (JP 2003-219794A) the freezing step. Further, to improve appearance and prevent cupping (concave depression on the top surface) of bread such as Pullman bread, JP 8-029045B discloses a method of applying oil/emulsion water to baked bread before the core temperature reaches 80° C. and below.

According to the cooling methods above, the surface temperature of food is higher than the dew point temperature of the atmosphere so that water evaporation of food inevitably occurs. Further, the yield rate of food becomes unstable, lines and cracking appear on the surface layer as the layer is being dried, and its quality, such as dry texture, deteriorates as the inner layer becomes dry. To solve the texture problems of bread, such as sandwich loaves, the bread crust, which is the hard surface layer, is cut off and discarded when making sandwiches or toasting bread. This method will create unnecessary processes, while wasting food. This method also does not improve the yield ratio.

Accordingly, there still remains a need to improve cooling of spongy heated foods, such as baked bread, Chinese steamed bread, and sponge cake, after the final heating process thereof, while minimizing deterioration of the quality. The present invention addresses this need.

### SUMMARY OF THE INVENTION

The present invention relates to a method and a system for cooling spongy heated foods such as baked bread, Chinese steamed bread, and sponge cake, after the final heating process thereof, such as baking, steaming, and frying.

One aspect of the present invention is a method of cooling spongy heated food that has undergone a final heating process. The method can include cooling the spongy heated food in an atmosphere containing cooling air and moisturizing the spongy heated food by exposing the spongy heated food in an atmosphere that permits the spongy heated food to absorb moisture. The atmosphere of the moisturizing step is at a temperature higher than the temperature of the atmosphere of the cooling step.

In the cooling step, the spongy heated food is cooled to make the surface temperature of the spongy heated food equal to or below a dew point temperature of the atmosphere in the moisturizing step.

According to another aspect of the present invention, the method includes a first step of applying water to the surface of the spongy heated food, a second step of promoting cooling of the spongy heated food using the latent heat of evaporation of the applied water, and a third step of exposing the spongy heated food cooled in the second step to an atmosphere having a dew point temperature higher than the surface temperature of the spongy heated food. The humidity in the third step is higher than in the second step to allow the spongy heated food to absorb moisture.

The surface of the spongy heated food can be applied with water in the first step in a normal indoor or outdoor environment of a process room. In the first step, water is applied evenly to the exposed surface of the spongy heated food immediately after the final heating process to form a layer of moisture thereon. Water can be applied up to three times in the first step, with the amount of water applied each time at 0.15 to 2% in weight of the spongy heated food.

The atmosphere surrounding the spongy heated food in the first step can be 15 to 40° C. and 20 to 80% RH, and the atmosphere surrounding the spongy heated food in the second step can be 5 to 15° C. and 30 to 60% RH, and the atmosphere surrounding the spongy heated food in the third step can be 10 to 20° C. and 60 to 90% RH. Air can be blown on the spongy heated food in each of the steps at the speed of 0.1 to 2 m/s. The spongy heated food can be exposed to the atmosphere of the second step until the surface temperature of the spongy heated food becomes near the temperature of the surrounding atmosphere. The first, second, and third steps can be performed sequentially in a single cooling chamber.

The ambient air in the third step can be moisture or a component addable to food or both. In the third step, the spongy heated food can absorb vaporized fragrant agents supplied to the atmosphere surrounding the spongy heated food. A bacteriostatic agent can be supplied to the atmosphere surrounding the spongy heated food to prevent a development of microorganisms on the surface and surface layer of the spongy heated food during the third step.

The method can further include slicing and packaging the cooled spongy heated food after the third step in an atmosphere having a dew point temperature equal to or above the dew point temperature of the second step or the surface temperature of the cooled spongy heated food. Alternatively, the method can further include freezing the cooled spongy heated food after the third step and thereafter packaging the frozen spongy heated food. Alternatively, the method can further include hermetically sealing the cooled spongy heated food with a packaging material having low water vapor permeability immediately after the third step and then freezing the hermetically sealed spongy heated food.

The method can further include freeze storing the hermetically sealed spongy heated food. The spongy heated food can be vacuum packaged after the third step with a packaging material having low air permeability so that the shape of the spongy heated food is maintained at the atmosphere of −26.6644 to −66.661 kPa. The spongy heated food can be stored at −15° C. and below ±1° C.

Another aspect of the present invention is a system for cooling spongy heated food that has undergone a final baking process. The system can include a first zone for applying water on the surface of the spongy heated food, a second zone for promoting cooling of the spongy heated food using the latent heat of evaporation of the applied water, and a third zone for retaining the cooled spongy heated food in an atmosphere having a dew point temperature higher than the surface temperature of spongy heated food. The humidity is set higher in the third zone than in the second zone to allow the spongy heated food to absorb moisture.

The first, second, and third zones can be all located in a single cooling chamber. The first, second, and third zones all can be formed sequentially in the cooling chamber. That is, the first, second, and third zones all can be located within the same physical space within the same cooling chamber at different times by varying the atmosphere conditions. The system can further include an atmosphere adjusting generator for generating and supplying an adjusted atmosphere to the cooling chamber to create a predetermined atmosphere in each of the zones in the cooling chamber, at least one sensor in the cooling chamber for sensing temperature, humidity, gas density, and the surface temperature of the spongy heated food, and a control unit for controlling the adjusting atmosphere generator based on the values detected by the sensor.

### BRIEF DESCRIPTION OF DRAWINGS

FIG. 1 schematically illustrates a cooling system according to the present invention.

FIG. 2 schematically illustrates another view of the cooling systems according to the present invention.

FIG. 3 is a table showing test results of the first example and the comparative example.

FIG. 4 is table showing sensory evaluations of the first example and the comparative example.

FIG. 5 is a graph illustrating temperature changes of the first example and comparative example.

FIG. 6 is a graph illustrating the yield rate of the first example and the comparative example.

FIG. 7 is a graph showing sensory evaluations of the first example and the comparative example.

FIG. 8 is a block diagram showing another embodiment of the cooling system according to the present invention.

### DETAILED DESCRIPTION

Preferred embodiments of the cooling system will now be detailed with reference to the accompanying drawings. It is intended, however, that unless particularly specified, dimensions, materials, relative positions and so forth of the constituent parts in the embodiments shall be interpreted as illustrative only not as limitative of the scope of the present invention.

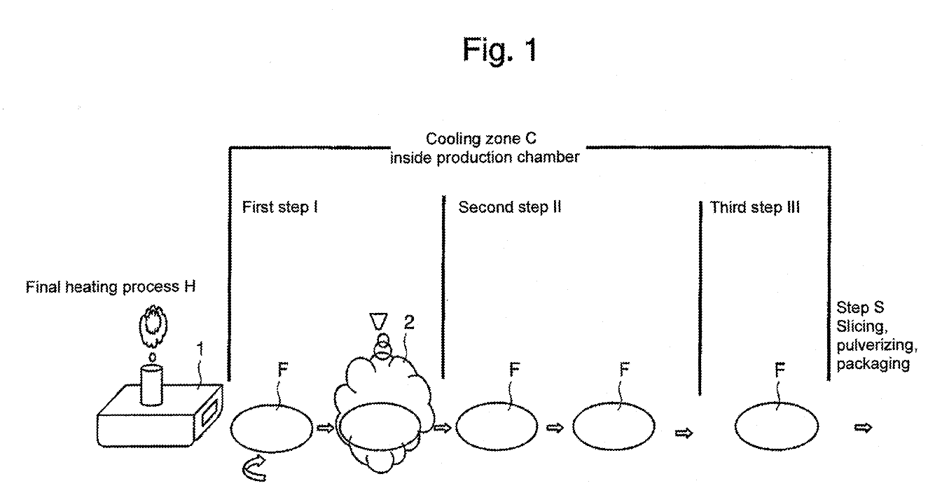

FIG. 1 shows a final heating process H where a heating unit 1, such as an oven, a steamer, a fryer, a baking unit, or a boiling unit, for performing the final heating process of spongy heated food F. The spongy heated food F having undergone the final heating process is moved to a first step or zone I inside a cooling zone C, such as a cooling production chamber. The food F enters the first zone at a temperature of around 90 to 98° C. In the first zone I, water is sprayed on the food F at an atmosphere of 15 to 40° C. and 20 to 80% RH so that the surface becomes wet evenly and the core temperature of the food F drops to 95° to 50° C. Water can be applied evenly to the exposed surface of the spongy heated food immediately after the final heating process to form a layer of moisture thereon. Water can be applied up to three times, each time at 0.1 to 2% in weight ratio of the spongy heated food. Air can be blown in the cooling zone C at 0.1 to 2 m/s to stir the atmosphere surrounding the spongy heated food in each zone to accelerate cooling.

The spongy heated food taken out of a final heating processor has a temperature of approximately 90 to 98° C. Spraying or applying (with a brush) water to form a thin layer of moisture promotes cooling of the spongy heated food due to the latent heat of evaporation of applied water, while reducing evaporation of water contained in the spongy heated food in correspondence to the amount of applied water, thereby enhancing the yield rate. Applying water to the spongy heated food is highly effective in cooling because the spongy heated food has a relatively high temperature, which means that it has a high water evaporation rate even in an atmosphere of high temperature and high humidity. Thus, even such an atmosphere of high temperature and high humidity, water applied to the spongy heated food evaporates so that the latent heat of evaporation takes a large amount of heat away from the spongy heated food. Accordingly, an air-conditioning unit for adjusting a temperature and humidity of the atmosphere is not needed, and normal indoor and outdoor environments of a process room suffice.

The sprayed food F, which has a temperature of 50-95° C. at the hottest part, is moved to the second zone or step 11 and exposed to the atmosphere of 5-15° C. and 30-60% RH so that water applied in the first zone and contained in the food F evaporates, lowering the potential heat of the food F by the evaporative latent heat to lower the temperature of the food F due to heat radiation and heat transfer from the surface of the food F. To prevent water evaporation from the surface and also from the core, the atmosphere of the second zone is set at a lower temperature in the range of 5 to 15° C. and generally at a lower humidity in the range of 30 to 60% RH. In this atmosphere, the surface layer of the food F is cooled faster, preventing water evaporation from the surface layer, maintaining the saturated state inside the crumb, thus preventing water evaporation from the core. The spongy heated food in the second zone II is cooled until the surface temperature becomes near the temperature of the surrounding atmosphere.

By controlling the process time in the second zone, water applied to the surface of the spongy heated food evaporates to prevent evaporation of water from the inner layer or core of the spongy heated food. The present method and system thus can minimize inevitable water evaporation from the food, while enhancing the cooling of the food F using the latent heat of evaporation of applied water.

The spongy food having undergone the processing in the second zone is moved to the third zone or step II, where it is exposed to the atmosphere of 10-20° C. and 60-90% RH, where the dew point temperature of the atmosphere is higher than the surface temperature of the food F to permit the surface layer of food to absorb moisture. In the third zone, the humidity is set higher than in the second zone to cause the food F to absorb moisture evenly while the moisture in the air is being condensed. Thus, the food restores moisture to compensate the amount of moisture evaporated in the second zone. The applied moisture keeps evaporating until the food is consumed. By controlling water evaporation during the cooling step, where the majority of total water evaporation of water after the final heating process happens, the yield rate of the spongy heated food can be enhanced while preventing the quality deterioration due to the dryness of the food.

During the moisturizing step in zone III, additives can be added, such as bacteriostatic agent, fragrant agent, etc., which can supplied to the atmosphere surrounding the spongy heated food. For instance, vaporized fragrant agents, such as vanilla and herbs, can be added to the atmosphere surrounding the spongy heated food so that it absorbs the vaporized fragrant agents, thus giving the desired flavor to the spongy heated food. For instance, a bacteriostatic agent can be added to the atmosphere surrounding the spongy heated food to prevent development of microorganisms on the surface and the surface layer of the spongy heated food.

The spongy food having undergone the third step is moved to the next zone or step S for slicing, pulverizing, and/or packaging. The temperature of the atmosphere during the slicing step and packaging step can be set equal to or below the dew point temperature of the preceding cooling step or the surface temperature of the cooled spongy heated food to prevent dryness and surface condensation on the spongy heated food.

The spongy heated food can be hermetically packaged in a packaging material having low water vapor permeability and then freeze-stored. By packaging the spongy heated food hermetically with such packaging material immediately after cooling, and then freezing the packaged spongy heated food, weight loss of the freeze-stored spongy heated food due to water evaporation can be prevented to enhance the yield rate. A packaging that is smaller and tighter better prevents water evaporation. The spongy heated food also can be frozen immediately after cooling, with or without being hermetically packaged. The spongy heated food also can be packaged in such packaging material in the atmosphere of −26.6644 to −66.661 kPa (i.e., vacuum) so that the shape of the food can be maintained. As the packaging is airtight and air space in the packaging is reduced, the amount of saturated water vapor needed to fill the space in the packaging becomes very small, thereby reducing the water evaporation amount of the spongy heated food. The packaged spongy heated food having undergone the freezing step is maintained at a temperature equal to or below −15° C. ±1° C. during freeze-storing and shipping.

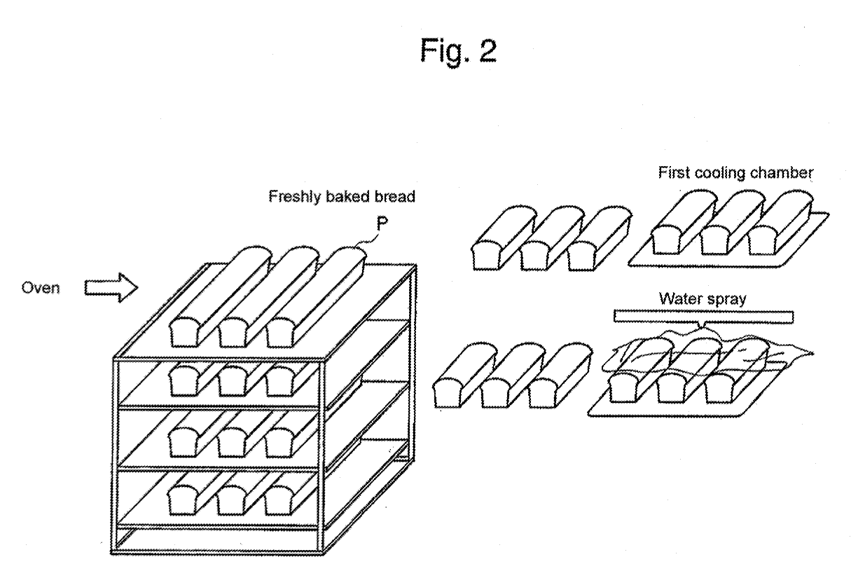

Specific examples of the cooling method are explained with reference to FIG. 2. After bread is baked in a conventional production facility (i.e., bread factory), bread is removed from a baking pan and six bread loaves were randomly taken out as samples from a batch of bread loaves. The bread tested here was whole-wheat English bread containing honey. A first set of three samples and a second set of three samples were placed on two different trays of large meshes made of stainless wires in the first cooling zone I. The first cooling zone was set at 29±0.5° C. and 70±5% RH inside a production chamber, which has an oven with an open door. The cooling zone, however, is in an area uninfluenced by radiant heat from the oven. Then fine water mist was sprayed evenly on the surface of the first set of samples placed on the tray, applying 0.50±5% of water in weight ratio of the bread, avoiding water spray on anything else. A thin layer of moisture was formed evenly on the surface of the sprayed samples without crust swelling or water dripping on the top surface. The second set of samples were kept away from the first set so that the sprayed water is not applied on the second set.

After the water spraying step, each sample from the first and second sets was placed parallel on three new trays of large meshes made of stainless wires with a clearance of 50 mm in the length direction, making first, second, and third groups each consisting of one water sprayed sample and one non-sprayed sample. Hereinafter, sprayed samples are described as G1-1, G2-1, and G3-1 in the first, second, and third groups respectively and non-sprayed samples are described as G1-2, G2-2, and G3-2 in the first, second, and third groups respectively.

For the first group, one of the conventional cooling methods was used to cool the samples for the total of 105 minutes in a cooling chamber set at 29±0.5° C. and 70±5% RH, with air blowing against the samples at the speed of 0.6 m/sec. For the second group, another conventional method was used to cool the samples also for the total of 105 minutes, but varied the atmosphere as follows: 5 minutes in the atmosphere of 29±0.5° C. and 70±5% RH, 50 minutes in the atmosphere of 15±1° C. and 70±10% RH, and finally 50 minutes in the atmosphere of 10±1° C., 50±10% RH, all while air was blown against the samples at the speed of 0.6 m/sec. For the third group, a cooling method according to the present invention was used, where the temperature and humidity of the third cooling step were set higher than those of the second cooling step. Specifically, the samples were cooled for the total of 105 minutes under the following conditions: 5 minutes in the atmosphere of 29±0.5C and 70±5% RH, 50 minutes in an atmosphere arbitrarily set at 10±1° C. and 50±10% RH, and finally for 50 minutes in an atmosphere of 15±1° C. and 70±10% RH, all while air was blown against the samples at the speed of 0.6 m/sec.

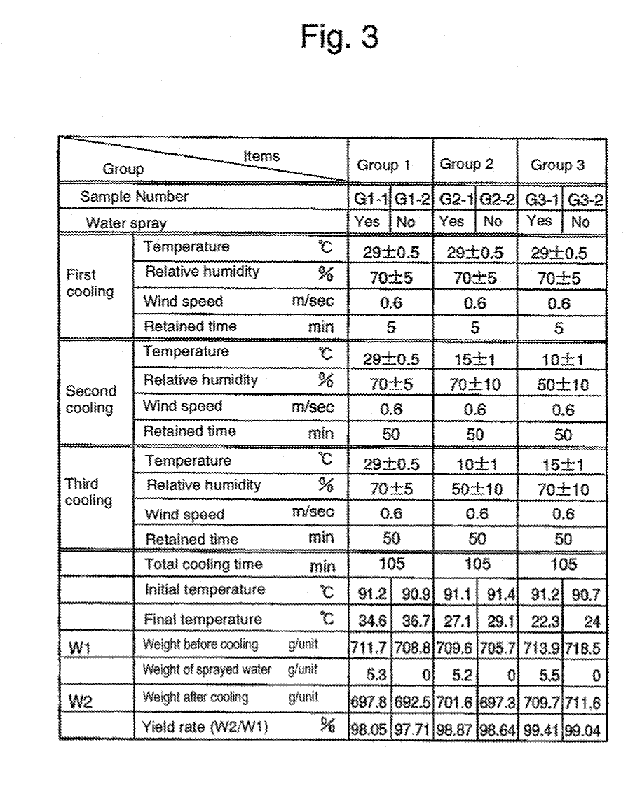

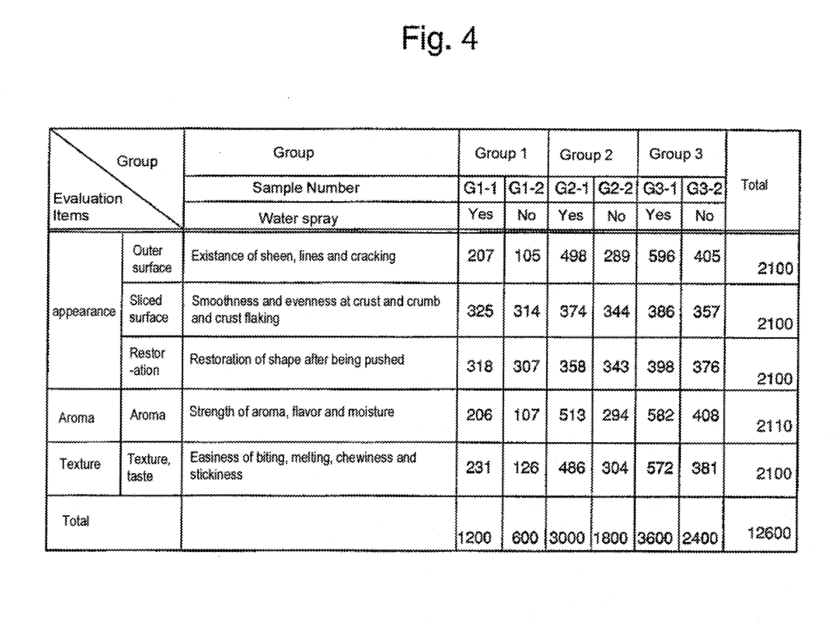

The temperature of each sample was taken by inserting a temperature sensor into its core to obtain time-series change of the core temperature of the samples from the beginning to the end of the cooling period. Each sample was weighed when it was taken out from the batch as a sample, and immediately after being water-sprayed (for sprayed samples only), and after completing the cooling process. After weighting each sample after completing the cooling process, each sample was sliced immediately equally into ten pieces and packaged hermetically in an air-filled packaging made of resin film. The packaged sample was stored for 48 hours at a room temperature (25° C.) and evaluated for sensory tests. The above cooling test was repeated five times and the average of the initial temperature and weight of the applied water. The cooling conditions of the atmosphere and the cooling time are shown in FIG. 3 and the result of the sensory tests are shown in FIG. 4.

The sensory test was performed by twenty testers. The testers took out sample bread loaves for the first, second, and third groups from a batch of loaves baked in the same oven at the same time (hereinafter called same sample group). The samples were cooled by the above designated method of each group. After being stored, the samples were evaluated by the twenty testers without disclosing the cooling methods. The samples were evaluated by the testers on the scale of 6 to 1 with respect to evaluation items of FIG. 4, in order of excellence of the sample sensory. FIG. 4 shows the total score of the five tests on each sample group. In each test, samples were evaluated according to the following scale: 6: excellent, 5: fairly good, 4: good, 3: slightly poor, 2: poor, 1: worst.

The details of the sensory test are described below. Samples are evaluated on scale from 6 to 1 because the same facility does not always produce a food product of the same quality. For example, bread dough of a same batch kneaded in the same mixer can differ in fermentation progress and density from the first formed loaf and the last formed loaf. Similarly, a first batch and a second batch baked in the same oven can show different baking results and post-baking conditions. Therefore, it is comparatively difficult to evaluate bread based on an absolute number such as 6 for a sample with one line on a crust surface and 1 for a sample with six or more lines or according to the size of lines. Specifically, every sample is already different at the time it is taken out from the batch immediately after baking. A fair evaluation can be done by evaluating each sample of the same sample group with respect to the evaluation items in order of sensory quality. Thus, the above evaluation method was adopted to test the samples.

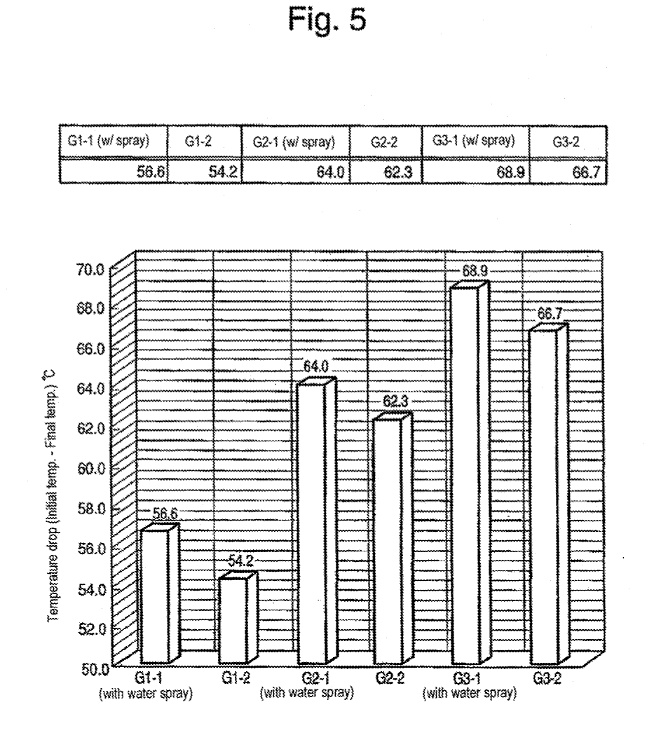

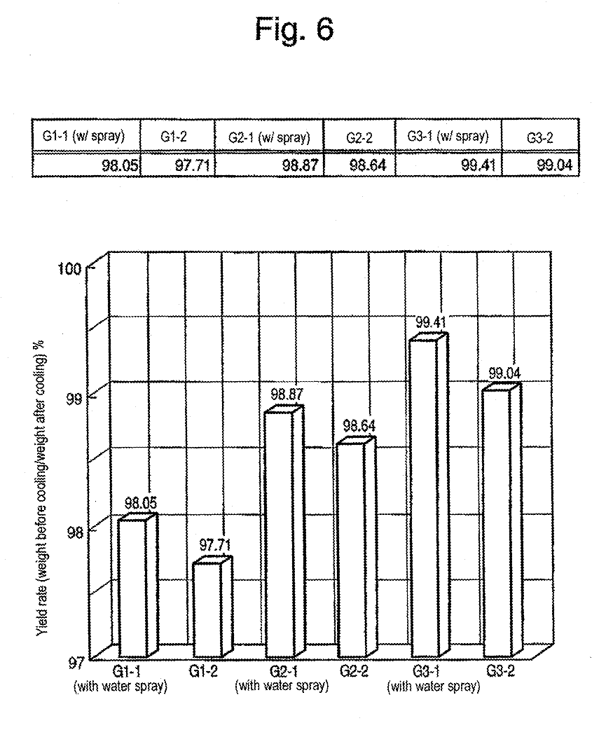

When sample G3-1 of Group 3 was compared with sample G3-2 of Group 3, observed were an increase in the yield rate as shown in FIG. 3 and FIG. 6 (based on FIG. 3), and a decrease in the core temperature by about 2° C. for the same cooling time as shown in FIG. 5 (based on FIG. 3). Moreover, a lower core temperature, i.e., faster cooling and higher yield rate, was observed in the sprayed samples in each of the sample groups. The sprayed samples thus cooled faster because the sprayed water on the crumb surface evaporated, taking the evaporative latent heat. The temperature drop depends on the atmosphere pressure and temperature and the temperature of the water spray. Under the atmosphere pressure, heat of approximately 2,218.6 j per gram of water was drawn from a sample. Therefore, the heat quantity drawn from the sample due to the heat transfer from the sample to the ambient air, and the heat quantity lost due to heat radiation from the sample, and the quantity of the evaporative latent heat of the sprayed water were added together. For example, 5 g of water was sprayed on a sample that had specific heat of 2.930235 J/° C.g and a weight of 700 g/unit. The averaged temperature drop due to evaporative latent heat of the applied water can be calculated as follows:
Evaporative latent heat: 5 g×2,218.6 J/g=11,093 J
Temperature drop: 11,093 J÷(700 g×2.930235 J/° C.g)=5.4° C.

The averaged temperature drop is an average of the temperatures of all the samples. Due to the heat transfer of the sample, the temperatures of the sample even out eventually in greater portion thereof in a considerable amount of time. However, the core temperature and the surface temperature remain different during a given cooling time according to the present invention. An evaporative latent heat of sprayed water adhering on the surface does not have much effect on the drop in the core temperature.

As can be seen from FIG. 6 (based on FIG. 3), in each group the samples having been water-sprayed on the crust surface has a higher yield rate. In other words, water evaporation is less in the sprayed sample because sprayed water adhering on the crust evaporates first and then water contained in the sample evaporates. Further, Group 3 adopting the cooling method according to the present invention showed the highest yield rate among the three sample groups. This is because the sample was cooled so that the surface temperature became equal to or below the dew point temperature in the second cooling step, and the sample was processed to make the surface temperature above the dew point temperature by the third cooling step in which water vapor in the ambient air adheres on the surface of the sample.

The second cooling condition was at an atmosphere of 10° C. and high humidity of 60% RH and low humidity of 40%. Maintaining the second cooling condition bears many technical difficulties. Construction of the facility is very costing. Dew condensation tends to occur on the surfaces of walls, floors, ceilings, and machinery provided inside the cooling chamber, which can cause a development of microorganisms. Sprayed water adhering to the surface of a sample cannot easily evaporate at a low temperature and high humidity, which can cause swellings on the surface layer of the sample. Water contained in the sample tends to evaporate from the inside and when the cooling step completes, water vapor moving to the surface condenses near the surface, which can form a layer containing a large amount of irreversible water (herein called white ring). Indeed, when the temperature difference between the spongy heated food and the atmosphere is large, moisture evaporated from the inner layer of the spongy heated product is overly condensed near the surface layer and the condensed moisture is absorbed in the spongy heated product, forming the white ring or lines on the surface, and lowering the product value. Thus, in consideration of lowering the cost of the facility construction and the product quality, the second cooling condition was set as described above.

Immediately after cooling, the cooled samples of each group were sliced and packaged. The packaged samples were stored at a room temperature (25° C.) for 48 hours and evaluated for sensory qualities. The sensory evaluation items were appearance, aroma, and texture. The appearance was judged based on appearances of the outer surface and the sliced surface, and also the restoration of its shape after pushing the sliced sample with a hand. The aroma was judged based on existence and strength of bread-specific aroma and undesirable smell. The texture was judged based on easiness of biting (poorly processed bread becomes chewy at and around the crust, which causes non-smooth biting and flaking of crust), and textures such as moisture, melting in a mouth, dryness, and stickiness on teeth. All these items were evaluated by twenty testers in scale of 6 to 1.

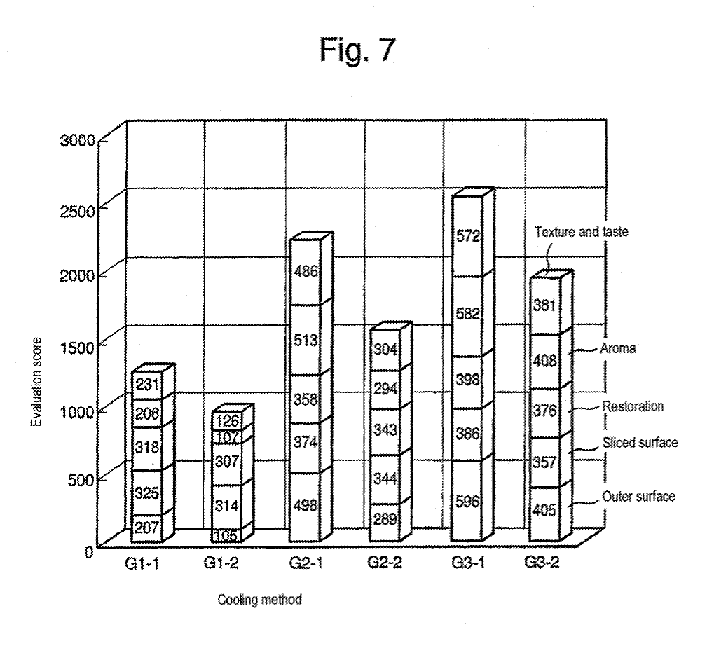

FIG. 4 shows the result of tests performed by twenty testers five times on a set of six samples each time. FIG. 7 shows the result of FIG. 4 as a graph. As can be seen from FIG. 4, each sample that was water-sprayed evenly on its surface obtained the best scores in the sensory tests. The samples that got the best score were Group 3 having been water-sprayed during the first cooling step and cooled during the second cooling step at a lowest humidity, and cooling during the third cooling step at a temperature higher than the dew point temperature of the second cooling step according to the cooling method of the present invention. The cooling method according to the present invention, in comparison to conventional cooling methods, enhances the yield rate and the quality of the product by cooling the product in a shorter time, saving energy, and space.

A second example of the present invention follows. Samples were sliced and packaged in a similar manner as the first example, and stored in a freezing chamber of −25° C. for 24 hours. And then frozen samples were stored in a freeze-storing chamber of −20° C. for 14 days and the frozen samples were thawed unattended without removing the packaging to a room temperature (20° C.). The samples were weighed and evaluated for sensory tests when a core temperature reached 18° C. and above. Hereinafter, the samples that were freeze-stored and thawed will be called freeze-stored samples F1-1, F1-2, F1-3, F2-1, F2-2, F2-3, F3-1, F3-2, F3-3 corresponding to the samples of the first example.

The sensory tests showed that the sample F3-1 that was water-sprayed and freeze-stored showed only a small difference from the sample G3-1 of the first example that was water-sprayed and not frozen, freeze-stored, or thawed. The difference was so small that the testers could hardly recognize. On the other hand, every tester could tell a difference between the sample F2-1 of the second example and the sample G2-1 of the first example. The testers could also tell a distinctive difference between the sample Fl-1 of the second example and the sample G1-1 of the first example.

In comparison with the samples of the first example that was not water-sprayed, namely G1-2, G2-2, G3-2, the samples of the second example that was freeze-stored without water spray, namely F1-2, F2-2, F3-2, showed more lines and cracking on the surface, and also crust flaking and formation of a thick surface layer in the order of F1-2, F2-2, and F3-2. The samples F1-1 and F2-1 that were water-sprayed and freeze-stored showed less occurrence of the above problems compared to the samples without water spray. The sample F3-1 showed no line or cracking on the surface, or crust flaking or formation of a thick surface layer.

According to the second example, in comparison to the samples of the first example that were cooled and then stored at a room temperature (20° C.) for 48 hours, in samples of the second example, excluding the sample F3-1, a loss of bread elasticity, occurrence of granular structure and lines, cracking on the surface, a loss of sheen surface, and deterioration of melting texture were observed.

According to the result of the weight and sensory tests of the second example, as with the samples of the first example that were stored at a room temperature (20° C.) for 48 hours, among the samples that were water-sprayed evenly, the sample that were processed by the second cooling process at the lower temperature and humidity and by the third cooling step at the higher temperature equal or above the dew point temperature of the second cooling step showed the best result.

Therefore, it can be concluded that the most effective cooling method is the cooling method according to the present invention, where the first cooling step included spraying water to form an even layer of moisture on the surface of bread, and the second cooling step included cooling bread in the atmosphere of a lower temperature and a lower humidity, and the third cooling step included cooling bread at a temperature higher than the dew point temperature of the second cooling step, with the first cooling step having the highest temperature and humidity among all three cooling steps. Compared to conventional methods, the method of the present invention enables a cooling of a food product in a shorter time to increase the yield rate and the quality of the product.

The cooling method according the present invention thus can save energy to improve the productive efficiency due to the transition of production on orders to production by plan using the freezing method, downsizing production facilities, reducing product discarding due to time degradation, and reducing production cost by utilizing resources. Thus, it becomes possible to provide products of good quality and also to reduce the effects on the environment.

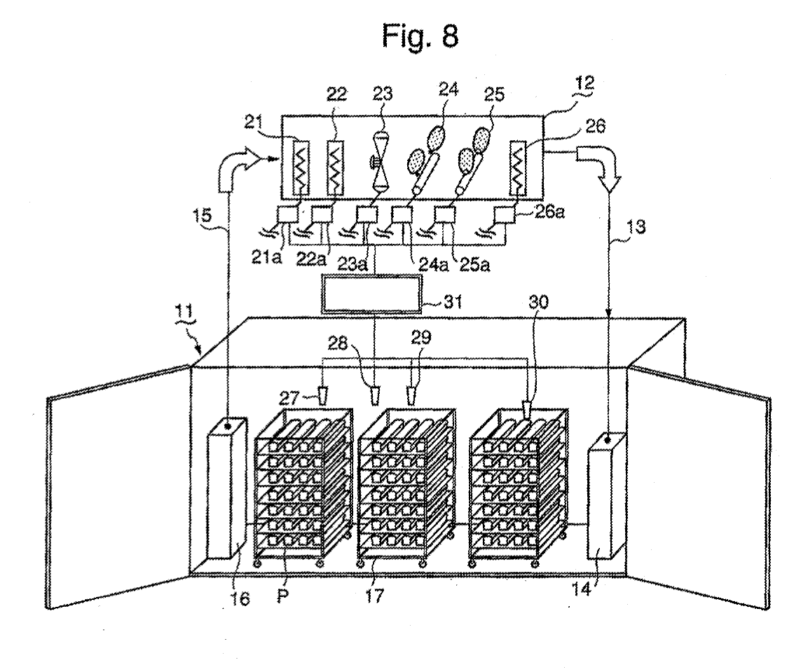

Referring to FIG. 8, the cooling system comprises a cooling chamber 11 for applying cooling steps to bread having undergone a final heating process, an adjusting atmosphere generator 12 for supplying an adjusting atmosphere, namely air, water vapor, and other gases, to create a predetermined atmosphere for each cooling step in the cooling chamber 11, a supply duct 13 for supplying the adjusting atmosphere generated by the adjusting atmosphere generator 12 to the cooling chamber, an outlet 14 for feeding the adjusting atmosphere to the cooling chamber 11, an intake duct 15 for taking out the atmosphere from the cooling chamber 11 and returning the atmosphere to the adjusting atmosphere generator 12 via an inlet 16 of the intake duct 15, and movable racks 17 for storing bread P therein after the final heating process.

The adjusting atmosphere generator 12 is provided with a first heat exchanger 21 for dehumidifying and connected to a heat supply device of cooling heat source (not shown) via an automatic valve 21a for adjusting the flow amount of dehumidifying air, a second heat exchanger 22 for cooling connected to a heat supply device via an automatic valve 22a for adjusting the flow amount of cooling air, a fan 23 connected to an air supply source (not shown) via an inverter 23a capable of changing the frequency, a steam generator 24 connected to a vaporizer or a water heating device (both not shown) via a flow control valve or a heat source controller 24a for heating water, a vaporizer 25, and a third heat exchanger 26.

The vaporizer 25 for vaporizing flavor liquids such as vanilla and herbs or bacteriostatic agent, or spraying agents dissolved in solvent, is connected to a supply source of the agents via an adjuster 25a for adjusting the spray amount. The third heat exchanger 26 of heating air is connected to a heat source (not shown) via an adjuster 26a such as a valve for adjusting a flow amount in the case of the heat source being steam or liquid such as warm water, or an electric controller in the case of the heat source being an electric heater.

A temperature sensor 27, a humidity sensor 28, a gas density sensor 29, and a crust temperature sensor 30 can be all provided inside the chamber 11. A control unit 31 operates feedback control of the adjusters 21a, 22a, 23a, 24a, 25a, and 26a based on the detected values from the sensors.

In the second embodiment of the cooling system, the adjusting atmosphere generator 12 generates the adjusting atmosphere to create a predetermined atmosphere in the cooling chamber 11 for each cooling step. In this case, the control unit 31 monitors the detected values from each sensor. The control unit 31 performs feedback control such that the adjusting atmosphere generator 12 generates adequate adjusting atmosphere to adjust the atmosphere inside the cooling chamber. Thus, a precise adjustment of the atmosphere appropriate for each cooling step can be achieved. Also, only one cooling chamber 11 is used to apply each cooling step sequentially, thus to simplify and downsize the facilities and save energy and resource. Further, the vaporizer 25 can feed bacteriostatic agent to the cooling chamber 11, thereby preventing development of microorganisms, and can feed flavor to bread P, thereby enhancing the added value of bread P. Although each cooling step can be performed sequentially in one cooling chamber, each cooling step can be performed in a separate cooling chamber. In that case, bread P can be moved either on a conveyor moving among each cooing chamber, or on a movable rack. Partitions such as air curtains can be provided to separate each cooling chamber.

The cooling process can be accelerated while improving the product quality by using the evaporative latent heat of the applied water, creating an atmosphere so that the vaporization of water contained inside the product does not occur, and creating an atmosphere where water adheres on the product. In this manner, it becomes possible to shorten the cooling time and improve the yield rate and the product quality.

In comparison to conventional cooling methods, by shortening the cooling time, it becomes possible to saves energy, space and ingredient, improving the productive efficiency due to the transition of production on orders to production by plan using the freezing method, downsizing production facilities, reducing product discarding due to time degradation, and reducing production cost by utilizing resources. Furthermore, by suppressing the deterioration of the spongy heated food due to the dryness, properties of food can be maintained longer. In regard to selling spongy heated food, the transition from production on orders to production by plan can be realized due to an extended storage time, and the spongy heated food can be stored for a longer time, thereby making possible expansion of the market. Furthermore, as the quality deterioration of spongy heated food is reduced, it is possible to eliminate the need to remove portion of poor quality such as crusts of a bread loaf during the reprocessing, and to consumers'benefit, enabling a long term storage of the spongy heated food with good appearance and soft texture. Thus, it becomes possible to provide products of good quality and also to reduce the effects on the environment.

In short, the present method and the system can achieve energy saving, downsizing, and simplification of cooling facilities, and to enhance and stabilize the yield rate of the product, and to improve the product quality and to prevent the quality deterioration.

While the present invention has been particularly shown and described with reference to preferred embodiments thereof, it will be understood by those skilled in the art that the foregoing and other changes in form and details can be made therein without departing from the spirit and scope of the present invention. All modifications and equivalents attainable by one versed in the art from the present disclosure within the scope and spirit of the present invention are to be included as further embodiments of the present invention. The scope of the present invention accordingly is to be defined as set forth in the appended claims.

What is claimed is:

1. A method of cooling spongy heated food that has undergone a final heating process, the method comprising the step of:
cooling the spongy heated food in an atmosphere containing cooling air; and
moisturizing the spongy heated food by exposing the spongy heated food in an atmosphere that permits the spongy heated food to absorb moisture, wherein the atmosphere of the moisturizing step is at a temperature higher than the temperature of the atmosphere of the cooling step.

2. The method according to claim 1, wherein in the cooling step, the spongy heated food is cooled to make the surface temperature of the spongy heated food equal to or below a dew point temperature of the atmosphere in the moisturizing step.

3. A method of cooling spongy heated food that has undergone a final heating process, the method comprising:
a first step of applying water to the surface of the spongy heated food;
a second step of promoting cooling of the spongy heated food using the latent heat of evaporation of the applied water; and
a third step of exposing the spongy heated food cooled in the second step to an atmosphere having a dew point temperature higher than the surface temperature of the spongy heated food, wherein the humidity in the third step is higher than in the second step to allow the spongy heated food to absorb moisture.

4. The method according to claim 3, wherein the surface of the spongy heated food is applied with water in the first step in a normal indoor or outdoor environment of a process room.

5. The method according to claim 3, wherein the atmosphere surrounding the spongy heated food in the first step is 15 to 40° C. and 20 to 80% RH, and the atmosphere surrounding the spongy heated food in the second step is 5 to 15° C. and 30 to 60% RH, and the atmosphere surrounding the spongy heated food in the third step is 10 to 20° C. and 60 to 90% RH.

6. The method according to claim 3, wherein airflow having a wind speed of 0.1 to 2 m/s is created in the atmosphere surrounding the spongy heated food in each of the steps.

7. The method according to claim 3, wherein the spongy heated food is exposed to the atmosphere of the second step until the surface temperature of the spongy heated food becomes near the temperature of the surrounding atmosphere.

8. The method according to claim 3, wherein in the first step water is applied evenly to the exposed surface of the spongy heated food immediately after the final heating process to form a layer of moisture thereon.

9. The method according to claim 3, wherein water is applied up to three times in the first step, with the amount of water applied each time is 0.15 to 2% in weight of the spongy heated food.

10. The method according to claim 3, wherein an ambient air in the third step is at least one of moisture or a component addable to foods.

11. The method according to claim 10, wherein in the third step, the spongy heated food absorbs vaporized fragrant agents supplied to the atmosphere surrounding the spongy heated food.

12. The method according to claim 10, wherein in the third step, a bacteriostatic agent is supplied to the atmosphere surrounding the spongy heated food to prevent a development of microorganisms on the surface and surface layer of the spongy heated food.

13. The method according to claim 3, further comprising the step of slicing and packaging the cooled spongy heated food after the third step in an atmosphere having a dew point temperature equal to or above the dew point temperature of the second step or the surface temperature of the cooled spongy heated food.

14. The method according to claim 3, further comprising the steps of freezing the cooled spongy heated food after the third step and thereafter packaging the frozen spongy heated food.

15. The method according to claim 3, further comprising the steps of hermetically sealing the cooled spongy heated food with a packaging material having low water vapor permeability immediately after the third step and then freezing the hermetically sealed spongy heated food.

16. The method according to claim 15, further comprising the step of freeze storing the hermetically sealed spongy heated food.

17. The method according to claim 3, further comprising the step of vacuum packaging the spongy heated food after the third step with a packaging material having low air permeability so that the shape of the spongy heated food is maintained at the atmosphere of −26.6644 to −66.661 kPa.

18. The method according to claim 3, further comprising the steps of packaging and freezing the spongy heated food, and then freeze storing the frozen spongy heated food at −15° C. and below ±1° C.

19. The method according to claim 3, wherein the first, second, and third steps are performed sequentially in a single cooling chamber.

20. A system for cooling spongy heated food that has undergone a final baking process, the system comprising:
a first zone for applying water on the surface of the spongy heated food;
a second zone for promoting cooling of the spongy heated food using the latent heat of evaporation of the applied water; and
a third zone for retaining the cooled spongy heated food in an atmosphere having a dew point temperature higher than the surface temperature of spongy heated food, wherein the humidity is set higher in the third zone than in the second zone to allow the spongy heated food to absorb moisture.

21. The system according to claim 20, further comprising:
at least one cooling chamber, wherein the first, second, and third zones are in the cooling chamber;
an atmosphere adjusting generator for generating and supplying an adjusted atmosphere to the cooling chamber to create a predetermined atmosphere in each of the zones in the cooling chamber;
at least one sensor in the cooling chamber for sensing temperature, humidity, gas density, and the surface temperature of the spongy heated food; and
a control unit for controlling the adjusting atmosphere generator based on the values detected by the at least one sensor.

22. The system according to claim 21, wherein the first, second, and third zones are formed sequentially in the cooling chamber.
